(19) United States
(12) Patent Application Publication
(10) Pub. No.: US 2011/0316674 A1
(43) Pub. Date: Dec. 29, 2011

(54) ASSET TRACKING SYSTEM INCLUDING A TAG CONTROLLER

(75) Inventors: Ryan D. Joy, Austin, TX (US); Michael R. Primm, Austin, TX (US); Richard N. Jefts, Austin, TX (US)

(73) Assignee: RF CODE, INC., Austin, TX (US)

(21) Appl. No.: 13/115,510

(22) Filed: May 25, 2011

Related U.S. Application Data
(60) Provisional application No. 61/348,130, filed on May 25, 2010.

(51) Int. Cl. G06K 7/01

(52) U.S. Cl. 340/10.1

(57) ABSTRACT

A plurality of tags communicates a plurality of messages to a reader device. A message collector at the reader device collects at least a subset of the received messages, and provides the collected messages to a set of logical readers. The message collector and the logical readers filter the collected messages based on configuration information provided by an associated application, and provide tag event information to the application based on the filtered messages. The reader device can be configured based on customized configuration information, so that the tag event information provided to an application is customized for that application.

### CROSS-REFERENCE TO RELATED APPLICATION(S)

The present application is a non-provisional of U.S. Provisional Patent Application No. 61/348,130, entitled “ASSET TRACKING SYSTEM INCLUDING A TAG CONTROLLER” filed on May 25, 2010, the entirety of which is herein incorporated by reference.

### FIELD OF THE DISCLOSURE

This disclosure, in general, relates to tracking systems, and in particular, radio frequency identification (RFID) tracking systems.

### BACKGROUND

With the increasing complexity of commercial organizations, industry is seeking to track the location and use of inventory and equipment with increasing specificity and detail. Accordingly, various industries are turning to asset tracking systems that include electronically readable identification tags. More recently, industry has turned to active identification systems, such as active radio frequency identification systems. Active radio frequency identification systems generally include radio frequency identification tags that periodically transmit radio frequency signals to indicate the presence of the tag. A reader device receives the signals and provides information based on the signals to one or more applications. The one or more applications compile and format the information so that it can be presented to a user or to another application.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a tracking system according to one embodiment of the present disclosure.

FIG. 2 is a block diagram of the reader device of FIG. 1 in accordance with one embodiment of the present disclosure.

FIG. 3 is a block diagram illustrating operation of the reader device of FIG. 1 in accordance with one embodiment of the present disclosure.

FIG. 4 is a block diagram illustrating operation of the reader device of FIG. 1 in accordance with one embodiment of the present disclosure.

FIG. 5 is a flow diagram of a method of communicating tag events in accordance with one embodiment of the present disclosure.

FIG. 6 is a flow diagram of a method of determining a set of tags for communication of tag events in accordance with one embodiment of the present disclosure.

FIG. 7 is a flow diagram of a method of configuring a logical reader in accordance with one embodiment of the present disclosure.

FIG. 8 is a block diagram of the reader device of FIG. 1 in accordance with one embodiment of the present disclosure.

FIG. 9 is a block diagram of a tracking system in accordance with one embodiment of the present disclosure.

The use of the same reference symbols in different drawings indicates similar or identical items.

### DETAILED DESCRIPTION OF THE DRAWINGS

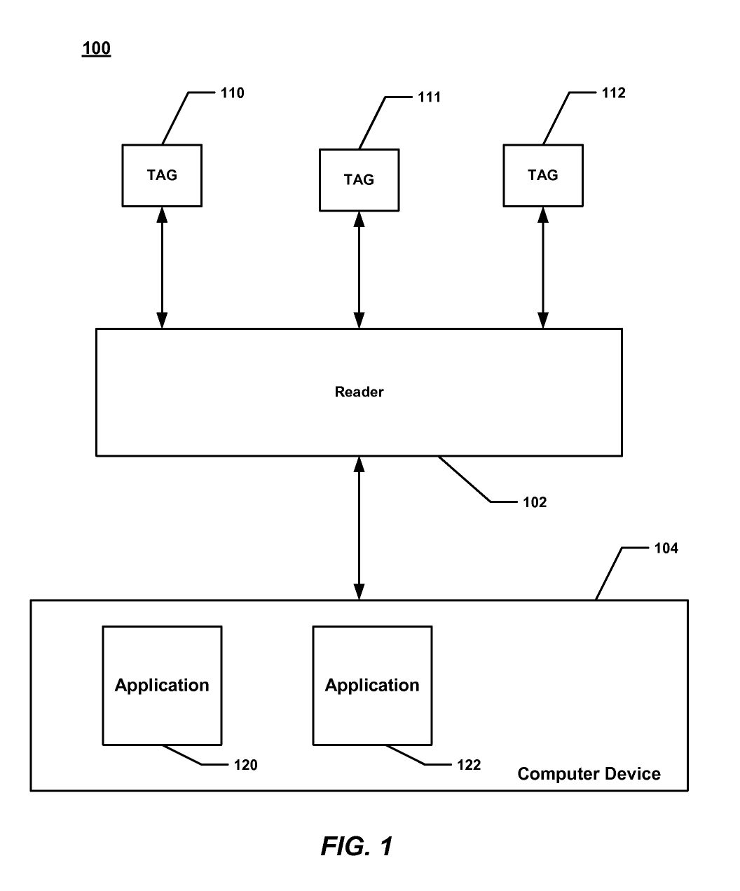

FIGS. 1-9 illustrate a device and methods for communicating tag events to multiple applications. As described herein, a plurality of tags communicates a plurality of messages to a reader device. A message collector at the reader device collects at least a subset of the received messages based on a combination of criteria provided by one or more remote applications, and provides the collected messages to a set of logical readers. Each of the logical readers filters the collected messages based on configuration information provided by an associated remote application, and provides tag event information to the remote application based on the filtered messages. A logical reader can be configured based on customized configuration information, so that the tag event information provided to a remote application is customized for that application. Such a reader and system can simplify the design and programming of the application and reduce overhead at the computer device executing the application, as well as reduce the number of reader devices needed to communicate with different applications.

FIG. 1 is a block diagram of a tracking system 100 in accordance with one embodiment of the present disclosure. The tracking system 100 includes a reader 102, a computer device 104, and tags 110, 111, and 112. The reader 102 can communicate with each of the tags 110-112. In addition, the reader 102 is communicatively coupled to the computer device 104. In an embodiment, the reader 102 and the computer device 104 are each coupled to communication network (not shown), such as a local area network (LAN), wide area network (e.g., the Internet), or the like. In another embodiment, the reader 102 is coupled to the computer device 104 via a universal serial bus (USB) connection, serial or parallel port, or other standard computer connection. In an embodiment, the reader 102 can communicate with additional computer devices (not shown) each executing one or more applications.

The tracking system 100 is operable to communicate information between the tags 110-112, the reader 102, and the computer device 104 to track the location or status, or a combination thereof, of different objects, referred to herein as assets. To facilitate location tracking, each of the tags 110-112 periodically transmits information indicating the status, or location, or combination thereof, of the associated tag. In one embodiment, an infrared beacon (not shown) periodically or continuously broadcasts an infra-red (IR) signal. Each of the tags 110-112 can include an IR receiver to detect the broadcast signal. Based on whether a tag detects the IR signal, and on one or more characteristics of the IR signal, the tag can determine its position and other status information.

Each transmission of status information by a tag is referred to as a “tag message.” In an embodiment, each tag message is communicated wirelessly via radio frequency (RF) transmission. Each tag message can indicate the status of the associated tag, such as the location of the tag, whether the tag is in active or power-saving mode, whether the tag is in motion or has been moved from a previously reported location, or the like. Each of the tags 110-112 can be affixed to an asset designated for tracking, so that each tag message indicates the status of the associated asset. In addition, one or more of the tags 110-112 can include one or more sensors to sense environmental conditions at or near the associated tag, such as temperature, humidity, pressure, or other environmental conditions. The information provided by one or more sensors to a tag is referred to as sensor information. Each tag message communicated by a tag can include sensor information in a payload of the tag message. In addition, each tag message can include information about the tag communicating the message, including a tag identifier that uniquely identifies the tag, a group identifier that identifies a group of tags to which the communicating tag belongs, or the like.

The reader 102 is a device operable to receive tag messages and process the messages for subsequent analysis. In particular, the reader 102 can include physical interfaces to receive tag messages communicated via wireless RF transmission. As described further herein, the reader 102 is operable to filter and format received tag messages to communicate information to one or more remote applications. The information communicated by the reader 102 to an application based on a tag message is referred to as a tag event. Each tag event can be associated with a corresponding received tag message. Further, a tag event can be identical to the tag message upon which it is based or can be a reformatted tag message. In another embodiment, a tag event can include information, such as a data payload or portion thereof, extracted from a tag message. For example, a tag event could include sensor information included in a tag message, location information indicating the location of the tag that communicated the message, a tag identifier or group identifier for the tag that communicated the tag message, or any combination thereof.

The computer device 104 is a server, desktop computer, laptop, handheld computer, or other computer device operable to execute applications 120 and 122 remote from reader 102. Computer device 104 is further operable to receive tag events and provide each tag event to the application indicated by the event. Applications 120 and 122 are each configured to process received tag events to indicate the status of one or more assets to a user or another application. For example, each of the applications can provide a visual, audible, or other indicator to indicate that an asset is in an expected location, is in motion, or is not in the expected location. The notification allows the user to take appropriate action based on the tag status. Each of the applications can also store information based on the tag events, such as information indicating the location of each tag, sensor information reported by each tag, or the like. The stored information can be used by the applications to communicate the status of the tags to a user to allow the user to determine the status of one or more assets associated with the tags. For example, the application 120 could display a graph, based on sensor information received from one or more tags, illustrating the change in environmental conditions (such as temperature) in the vicinity of an asset. In addition or alternatively, information retrieved from the tags can be used to perform other calculations or presented in other forms.

To illustrate operation of the asset tracking system 100, each of the tags 110-112 can be, for example, affixed to a different associated asset. Each of the tags 110-112 periodically communicates tag messages to the reader 102 to indicate the status of the tag, thereby indicating the status of the associated asset. Each of the tags 110-112 can be configured individually, for example, to provide its associated tag messages at a designated message rate (e.g. number of messages communicated per unit of time), signal format, and message format.

The reader 102 receives the tag messages communicated by the tags 110-112 and, based on the messages, communicates tag events to the applications 120 and 122. The applications 120 and 122 process the tag events to determine the location of the assets associated with each tag. For example, if a tag event for tag 111 indicates that the IR signal from a beacon has not been received for a threshold amount of time, application 120 can determine that the asset associated with the tag has been moved from its expected location. In response to a tag event, the application 120 can provide a visual or other indication to the user, who can then take appropriate action. Examples of tag events that can trigger a notification or other action include a tag event that indicates a change in position of a tag (as indicated by changes in position information provided in a series of tag messages), sensor information or other payload information of a series of tag message, signal strength of an IR beacon signal to a tag, signal strength of an RF signal provided by a tag to the reader 102, other status information associated with a tag (such as an indication that a tag has entered or exited a low-power mode), or the like.

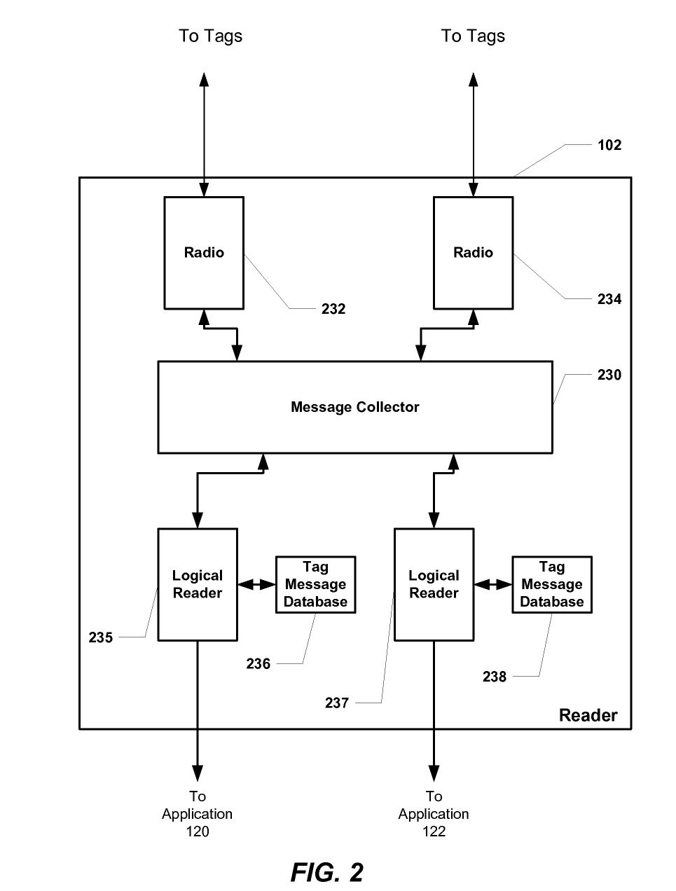

In the illustrated embodiment, the reader 102 can be configured to provide tag event information to each of the applications 120 and 122 in a fashion customized for each application. Thus, for example, the reader 102 can provide tag event information to application 120 based only on messages received from a first set of tags (e.g. tags 110 and 111) and provide tag event information to application 122 based only on messages received from a second set of tags (e.g. tag 112). In a further example, the applications 120 and 122 can be provided with tag event information for tags in different locations. In another embodiment, the reader 102 can filter messages such that application 120 receives only a portion of data from tag messages, while application 122 receives a different portion of the data. For example, the reader 102 can filter received messages so that only application 120 (and not application 122) receives sensor information indicating a detected radiation level and so that only application 122 (and not application 120) receives sensor information indicating a measured temperature level. In another embodiment, location information provided by one set of tags can be communicated to application 120 (and not to application 122), while payload information (such as sensor information) from the same set of tags is provided to application 122 and is not provided to application 120. The operation of reader 102 can be better understood with reference to FIG. 2.

FIG. 2 illustrates a block diagram of the reader 102 in accordance with one embodiment of the present disclosure. As illustrated, the reader 102 includes one or more radios, such as radios 232 and 234, a message collector 230, one or more logical readers, such as logical readers 235 and 237, and one or more tag message databases, such as tag message databases 236 and 238. The radios 232 and 234 are each configured to receive tag messages transmitted wirelessly via RF signals by the tags 110-112. Accordingly, the radios 232 and 234 can each include one or more antennas as well as other hardware to detect the transmitted messages and transform the messages to a format to be communicated to other modules of the reader 102. In an embodiment, the radios 232 and 234 can also transmit information to one or more of the tags 110-112. In an embodiment, each of the radios 232 and 234 are physically affixed to the reader 102. In another embodiment, one or more of the radios 232 and 234 can by physically remote from the reader 102 and communicate with the reader 102 via a network, wired connection, or wireless connection.

The message collector 230 is configured to receive tag messages and compare the tag messages to criteria, referred to as collector configuration information, to determine whether to communicate a tag event to one or more of the applications 120 and 122. The collector configuration information can be derived from criteria supplied by one or more remote applications, such as an aggregate or union of criteria supplied by at least two remote applications. To illustrate, the collector configuration information can indicate a variety of message criteria, such as signal strength of an IR signal broadcast by an IR beacon, signal strength of an RF signal communicated by a tag, one or more tag identifiers, one or more tag group identifiers, tag location information, tag status information, tag message rate, tag payload information, including sensor information, a tag sampling period, or the like, or any combination thereof. Based on this information, the message collector 230 determines whether a tag event for a received tag message is to be communicated to either of the applications 120 and 122 or optionally discarded. For example, tags can be grouped into different tag groups, with access to tag messages by each application restricted based on the tag group. The message collector 230 can determine, based on a received message's tag group information, whether either of the applications 120 and 122 are authorized to access information received from the tag that communicated the message. If neither application is authorized, the message collector can optionally discard the message. If one or more of the applications 120 and 122 is authorized to receive information from the tag that communicated the message, the message collector 230 can communicate the message to the logical readers, for example, only to those logical readers that are associated with the authorized applications. In another example, the tag messages may be selected based on location information.

In another embodiment, a tag message can indicate the signal strength of an IR signal received from an IR beacon. The message collector 230 compares the IR signal strength of the received message to a threshold indicated by the collector configuration information. If the IR signal strength indicated by the received tag message is below the threshold, the message collector 230 discards the message. If the signal strength of the received tag message is above the threshold, the message collector 230 provides the received tag message for processing as a tag event.

The logical readers 235 and 237 are software modules each associated with a different application. For example, in the illustrated embodiment, logical reader 235 is associated with application 120, while logical reader 237 is associated with application 122. While the applications 120 and 120 are illustrated as being on a single remote device 104, applications can reside on more than one remote device and a logical reader can be instantiated in association with each application. Each of the logical readers 235 and 237 is configured to receive tag messages and process the received messages based on tag event configuration information customized for the associated application. Thus, for example, each of the logical readers 235 and 237 can discard received messages that do not meet criteria indicated by the tag event configuration information associated with the logical reader. Further, each of the logical readers can communicate tag events to the associated application based on tag messages that meet the criteria indicated by the associated tag event configuration information. In an embodiment, the message collector 230 filters the received tag messages so that a different subset of the tag messages is provided to each of the logical readers 235 and 237. For example, the message collector 230 can filter the received tag messages based on a combination of criteria, such as a combination of tag group identification information indicated by each message, so that each of the logical readers 235 and 237 are provided tag messages from a different set of tags. The logical readers 235 and 237 can further filter the messages provided by the message collector 230 based on other criteria. For example, the logical reader 235 can collect received messages that indicate a change in specified sensor information, such as temperature information. In addition, each of the logical readers 235 and 237 can perform additional processing on received tag messages, such as extraction of portions of the data payload of the received tag messages, reformatting of received tag messages, comparing data from the received tag message to previously received values, or the like, to determine the tag events to be provided to the associated application. In addition, the logical readers 235 and 237 can persist when communication is lost with its associated application 120 and 122.

Accordingly, the message collector 230 and the logical readers 235 and 237 together filter received tag messages and process the received tag messages so that each of the applications 120 and 122 receive different tag events based on the received tag messages. The particular module of the message collector 230 and the logical readers 235 and 237 that perform particular filtering or processing can be adjusted to provide for flexible and efficient provision of the different tag events to each application. Thus, in one embodiment, the message collector 230 performs filtering operations and discards unwanted tag messages and the logical readers 235 and 237 reformat the tag messages or extract specified information from each message. In another embodiment, the message collector 230 performs a first level of filtering, such as excluding tag messages that are received from a tag group other than designated groups, while the logical readers 235 and 237 perform additional filtering and other processing. In still another embodiment, additional modules can be executed at the reader 102 to perform additional filtering and processing of received tag messages. Thus, for example, an additional module (not shown) can be interposed between the message collector 230 and the logical readers 235 and 237. The message collector 230 can perform a coarse level of filtering, such as discarding messages that are not received from tags associated with a particular tag group. The additional collector can perform additional filtering, such as excluding all tag messages that do not indicate a change in tag location information. Each of the logical readers 235 and 237 can then perform additional processing, such as reformatting each tag message received from the additional collector to a format expected by the associated application.

The logical readers 235 and 237 can be further configured to store received tag messages at the tag message databases 236 and 238 respectively. The logical readers 235 and 237 can access the respective database to compare stored and received messages to determine whether criteria, as indicated by the tag event configuration information associated with each logical reader, are met. For example, the tag event configuration information for logical reader 235 can indicate that a tag event should be communicated to application 120 only if a designated message field changes by a designated amount between successively received messages. Accordingly, logical reader 235 can store a first received message at the tag message database 236 and, upon receiving a second successive message from the same tag, compare the second tag message to the first tag message to determine if the criteria are met. The tag message databases 236 and 238 can also be used to maintain data integrity between communication sessions with the associated application. Thus, if a communication session with a particular application is lost or otherwise terminated, the tag message database associated with that application can be maintained, so that when the next communication session with the application is established, the tag messages stored in the database can be employed to provide the application with tag information in context of the tag message history. For example, the tag message database 236 can store a tag message indicating the position of a tag. The tag message is maintained after a communication session with application 120 has been terminated, so that when a subsequent communication session with application 120 is established, the position information of the stored tag message can be compared with position information indicated by a tag message received before and during the newly-established session. The comparison can indicate a history of the tag's movement during the period between the communication sessions.

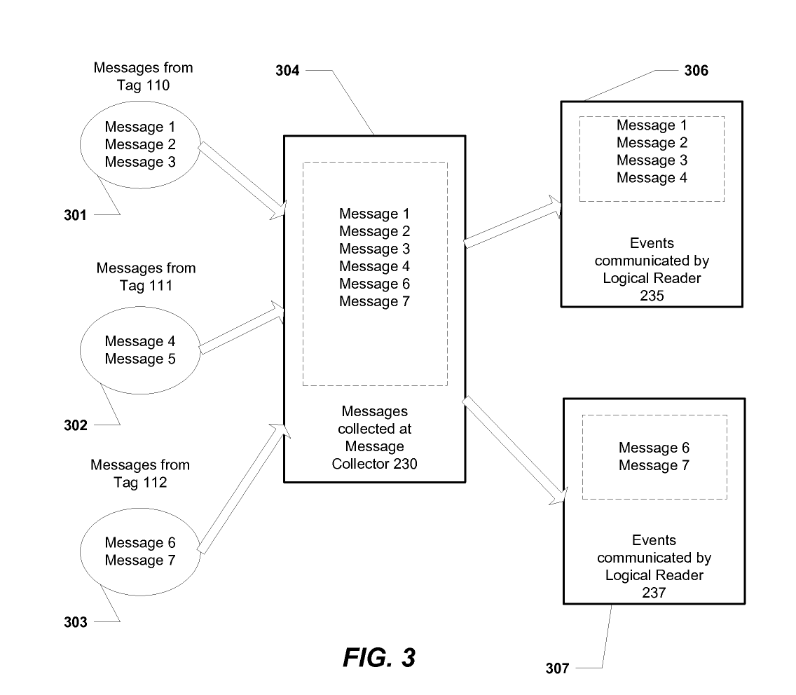

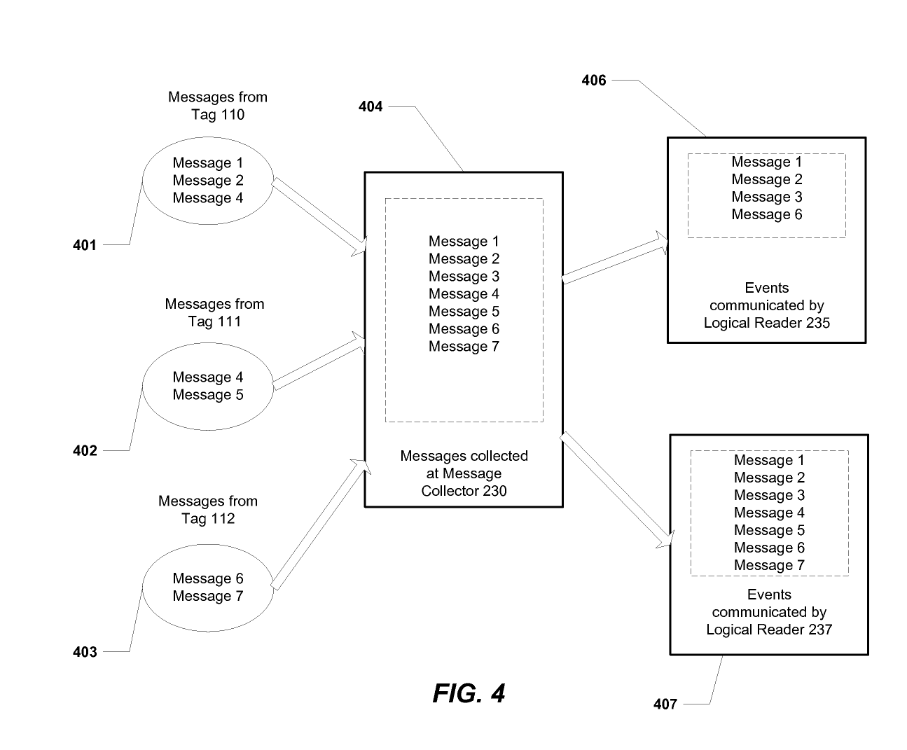

The operation of reader 102 can be better understood with reference to FIGS. 3 and 4, which illustrate exemplary operations of the reader 102 in accordance with specific embodiments of the present disclosure. With respect to FIG. 3, blocks 301, 302, and 303 illustrate tag messages received from tags 110, 111, and 112, respectively during a designated period of time. Block 304 illustrates the tag messages communicated by the message collector 230 to each of the logical readers 235 and 237. Block 306 illustrates tag events communicated by logical reader 235 to application 120 and block 307 illustrates tag events communicated by logical reader 237 to application 122.

In the illustrated example of FIG. 3, the reader 102 is configured to communicate tag events to application 120 based only on tag messages received from tags 110 and 111. Reader 102 is further configured to communicate tag events based only on tag messages received from tag 112 to application 122. Further message collector 230 can, for example, be configured so that messages having an RF signal strength below a threshold level are not communicated to the logical readers 235 and 237. Accordingly, as illustrated at block 304, message collector 230 does not communicate Message 5 to the logical readers, indicating that the signal strength of Message 5 is below the threshold level. Further, as illustrated at block 306, reader 102 communicates tag events to application 120 based only on Message 1, Message 2, Message 3, and Message 4, as those tag messages are received from tags 110 and 111. Reader 102 does not report tag events based on Message 6 and Message 7 to application 120, as those tag messages are received from tag 112. Similarly, reader 102 reports tag events to application 122 based only on Message 6 and Message 7, and does not report tag events based on tag messages received from tags 110 and 111. The filtering by reader 102 of tag messages based on tag groups can be performed by message collector 230, logical readers 235 and 237, or any combination thereof. For example, in one embodiment, message collector 230 filters the received tag messages so that logical reader 235 is not provided with any tag messages received from tag 112.

Thus, as illustrated by the example of FIG. 3, the reader 102 can be configured so that each of the applications 120 and 122 received tag events based on messages associated with a designated subset of available tags. Such selective communication can be useful in an environment where, for example, a common reader device is employed to read tags associated with assets owned by different users, or in which access to messages received from some tags is restricted.

Turning to FIG. 4, blocks 401, 402, and 403 illustrate tag messages received from tags 110, 111, and 112, respectively during a designated period of time. Block 404 illustrates the tag messages communicated by the message collector 230 to each of the logical readers 235 and 237. Block 406 illustrates tag events communicated by logical reader 235 to application 120 and block 407 illustrates tag events communicated by logical reader 237 to application 122.

In the illustrated example of FIG. 4, logical readers 235 and 237 can each be configured to communicate tag events based on different tag message rates. Thus, for example, logical reader 235 is configured to communicate tag events for tag messages received from a particular tag every 5 seconds, while logical reader 237 is configured to communicate tag events for tag messages received every second. Further, message collector 230 can be configured so that all received messages with particular tag identification, group identification, or location code are communicated to the logical readers 235 and 237. Accordingly, as illustrated at block 404, message collector 230 communicates every message received from the tags 110-112 to the logical readers 235 and 237. Further, as illustrated at block 406, logical reader 235 communicates data associated with Message 1, Message 2, Message 3, and Message 6, based on timing. Similarly, logical reader 237 reports tag events based on the received tag messages, and received tag messages for that logical reader.

Thus, as illustrated by the example of FIG. 4, the reader 102 can be configured so that each of the applications 120 and 122 received tag events based on different tag message rates. Such a configuration can be useful in an environment where, for example, different applications have different communication or processing bandwidths.

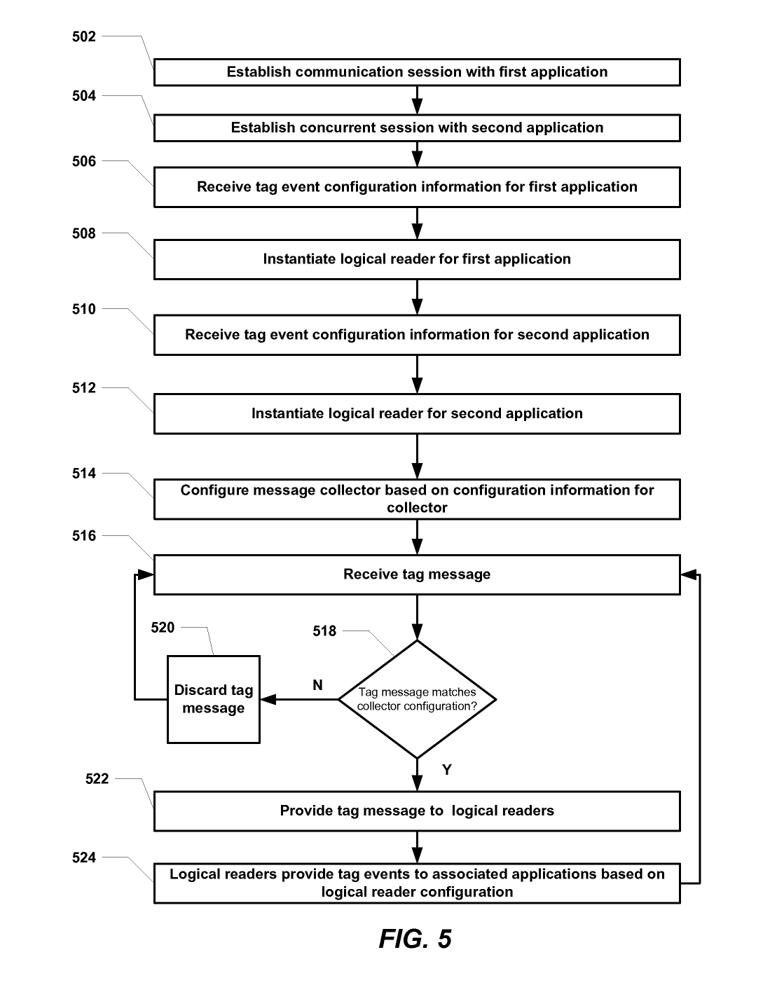

FIG. 5 illustrates a method of communicating tag events in accordance with one embodiment of the present disclosure. At block 502, a communication session is established between the reader 102 and the application 120. In an embodiment, the session can be established via a negotiation according to the communication protocol associated with the communication session. For example, if the communication session is to be a TCP/IP telnet session or HTTP/HTTPS communication session, the session can be established via negotiation according to the selected protocol. In another embodiment, the session is established by connection of a communication link, such as a hardware cable, between the reader 102 and the computer device 104. In another embodiment, the communication link between the reader 102 and computer device 104 is persistent over different communication sessions, and an individual session is established by the reader 102 in response to a request from the application 120. In another example, the reader 102 can communicate with applications residing on multiple remote computing devices.

At block 504, the reader 502 establishes a communication session with the application 122 at the computer device 104. The communication session can be established via the same communication link or a different communication link as the link used to establish the communication session with application 102. Thus, the communication sessions with each application can be individual HTTP/HTTPS, TCP/IP telnet, or secure shell (SSH) communication sessions or any combination thereof. In another embodiment, the communication session with application 120 can be conducted via a first hardware link (such as a USB port) while the communication session with the application 120 is conducted via a second hardware link (such as a different USB port, RS-232 port, or the like).

As illustrated at block 504, the communication sessions with the applications 120 and 122 are established so that the sessions are concurrent. As used herein, communication sessions are concurrent when the sessions are conducted such that at least one tag message is received by the reader 102 while both sessions are ongoing. In other words, a first communication session and a second communication session are concurrent if the first communication session is conducted for a first period of time (between establishment of the session and termination of the session) and the second communication session is conducted for a second period of time overlapping with the first period of time such that one or more tag messages are received by the reader during the overlapping period of time. As described herein, the reader 102 can report tag events for concurrent communication sessions in different fashions, with each fashion customized for each communication session, according to the application associated with the session.

To illustrate, at block 506, configuration information, which can include logical reader configuration information and tag event configuration information, for the application 120 is received at the reader 102. In an example, the logical reader configuration can include parameters to configure a logical reader to communication with the application, such as communication method, an identification number associated with the application or logical reader, or parameters defining persistence of the logical reader, or a combination thereof. The tag event configuration information can be predefined information stored at the reader 102, or configuration information provided by the application 120. The tag event configuration information indicates criteria for reporting a tag event, such as tag message frequency, tag message signal strength, tag identification information to identify those tags for which tag events should be reported, reader radio information to identify those reader radios for which tag events should be recorded, tag life cycle heuristics, or the like. The criteria can also include a change in payload data or a change in a value within the payload data.

At block 508, the reader 102 instantiates logical reader 235 based on the tag event configuration information for application 120. In an embodiment, logical reader 235 is an instance of a software object configured to filter out tag messages that do not meet the criteria tag event configuration information, so that the logical reader 235 reports events based only on tag messages that meet the indicated criteria.

At block 510, configuration information, including tag event configuration information, is received for the application 122. In an embodiment, the tag event configuration information for application 120 is different than the tag event configuration information for application 122, such that, based on a common set of tag messages, the logical readers 235 and 237 report different tag events. At block 512, the reader 102 instantiates logical reader 237 based on the tag event configuration for application 122.

At block 514, the message collector 230 is configured to provide tag messages that match configuration information for the message collector 230. In one embodiment, the configuration information configures the message collector 230 to provide tag messages that comply with an aggregation or union of criteria indicated by configuration information for each of the applications having an instantiated logical reader with the reader 102. The criteria can be associated with tag identification, group identification, location code, status with regard to movement, signal strength associated with a IR beacon, signal strength associated with the RF message, existence or type of payload data, other status parameters within the tag message, or any combination thereof. The message collector 230 and its functionality can be better understood with reference to an example, whereby the tag event configuration information for application 120 indicates a tag event should be reported for all messages having a signal strength above a first threshold (referred to as Threshold A) and the tag event configuration information for application 122 indicates a tag event should be reported for all messages having a signal strength above a second threshold (referred to as Threshold B), where Threshold A is less than Threshold B. Accordingly, when both applications 120 and 122 have an established communication session with reader device 120, message collector 130 will be configured to provide all tag messages having a signal strength above Threshold A to both logical reader 235 and logical reader 237. In other words, message collector 230 will provide all messages that meet the least-restrictive criteria based on all the tag event configuration information associated with all current communication sessions. As communication sessions are established and terminated, the configuration of message collector 230 can be adjusted to ensure that tag messages are being provided to the logical readers according to the least-restrictive criteria. Other messages can be disregarded or ignored.

In another embodiment, the configuration information for the message collector 230 can configure the collector to provide different tag messages to different logical readers. For example, the message collector 230 can be configured to provide to designated logical reader tag messages from only a subset of tags that provide tag messages to the collector. The message collector 230 can determine, for each tag message, the tag that provided the message based on a tag identifier or tag group identifier, location, or combination thereof. Only messages from tags in the designated subset are provided to the designated logical reader by the message collector 230. The message collector 230 can filter tag messages differently for different logical readers based on a variety of other criteria, including signal strength, message rate, payload information, and other information. In addition, the message collector 230 can be configured to provide different portions of a tag message to different logical readers. For example, the message collector 230 can provide a first portion of a data payload of a received tag message (such as, for example, payload information indicating a sensed temperature) to one logical reader and provide a different portion of the data payload (such as, for example, payload information indicating a sensed radiation level) of the same tag message to a different logical reader.

The message collector 230 can provide a tag message, or portion of a tag message, to a logical reader in a number of ways. In one embodiment, the message collector 230 can provide a tag message, or portion thereof, to a logical reader by storing the tag message or tag message portion in a database or queue uniquely associated with that logical reader, such that other logical readers cannot access that database. In another embodiment, the message collector can store received tag messages or portions thereof in a database or queue that is accessible by all logical readers. The tag messages (or message portions) can be stored with identifier information that indicates the logical readers that can access the message. The logical readers can be configured so that they can only retrieve tag messages or tag message portions from the database that have identifier information indicating the logical reader.

At block 516, a tag message is received from one of the tags 110-112. At block 518, the message collector 230 determines whether the received tag message should be communicated, based on the configuration of the collector described above. If the tag message does not meet the configuration information for the message collector 230 (for example, the configuration information indicates the tag message should not be provided to any logical reader), the method flow proceeds to block 520 and the message collector 130 discards the message. If the received tag message matches the configuration information for the message collector 230, the method flow moves to block 522 and the message collector 230 communicates the message to the appropriate logical readers as indicated by the configuration information for the collector. At block 524, each logical reader determines whether and how to report a tag event based on the received tag message based on the configuration information used to instantiate the logical reader.

In one embodiment, different logical readers can report the same tag events to the associated applications in different formats. Thus, for example, logical reader 235 can report a tag event by passing the entire message to application 120 in the same format as the message is received. Logical reader 237 can report a similar tag event by extracting a data payload, or portion of a data payload, from the message and provide the extracted information to the application 122.

In another embodiment, each logical reader can report tag events based on different tag life cycle heuristics. In particular, logical readers 235 and 237 can each report a tag event, indicating a tag is unavailable, when a message has not been received from a particular tag for a threshold amount of time, where the threshold amount of time is configured differently for each logical reader. Thus, logical reader 235 can report a tag is unavailable after failing to receive a message from a designated tag for 10 minutes, while logical reader 237 reports that a tag (either the same tag or a different tag) is unavailable only after failing to receive a message for 15 minutes. Accordingly, the availability of tags can be reported differently to applications 120 and 122, based on the tag life-cycle information associated with each application and instantiated in the respective logical reader.

In still another embodiment, each logical reader can report events based on different tag message rates. Thus, for example, logical reader 235 can be configured to report tag events for every 5 messages received from a particular tag, while logical reader 235 is configured to report tag events for every 12 messages received from a tag. Further, each logical reader can be configured to report tag events based on changes in designated tag message fields, with the particular fields, the magnitude of change, or the rate of change that leads to reporting of a tag event customized for each logical reader. Thus, for example, logical reader 235 can be configured so that a tag event is reported only if a tag message indicates that the position of the associated tag has changed by more than 10 feet in 2 minutes, while reader 237 is configured so that a tag event is reported only if the tag message indicates that the position of the associated tag has changed by more than 30 feet in 60 minutes.

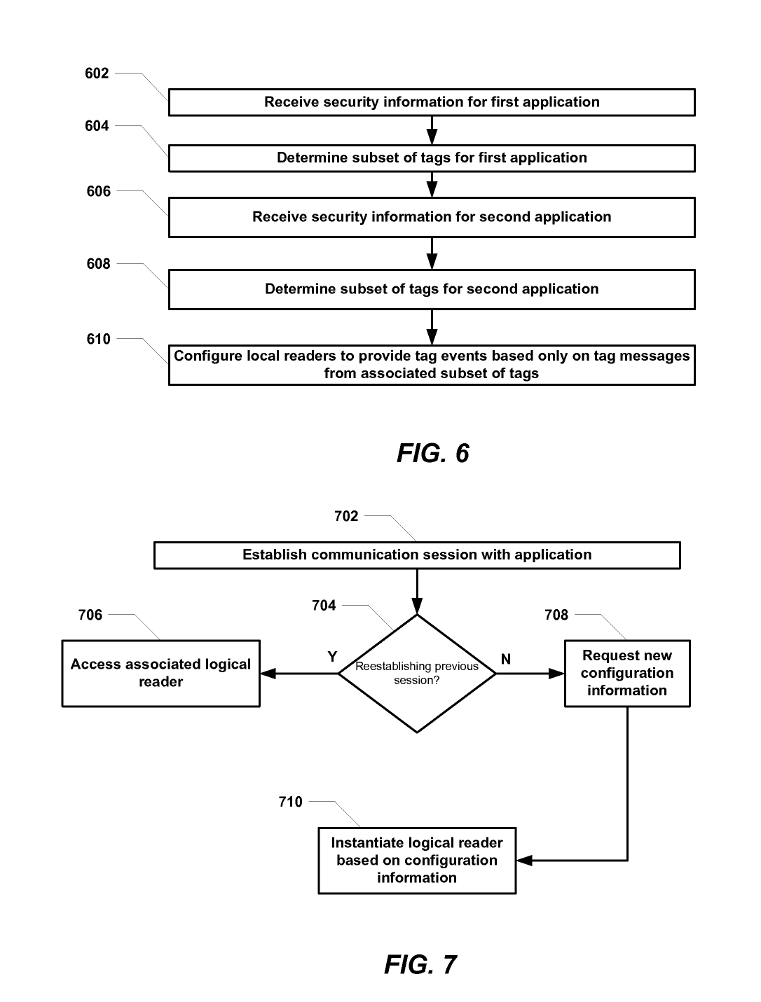

In addition, the reader can be configured so that tag events are only reported by the reader to a designated application for messages received from a designated tag or group of tags. Such functionality can be better understood with reference to FIG. 6, which illustrates a flow diagram of a method of communicating tag events for a group of tags in accordance with one embodiment of the present disclosure. At block 602, the reader 102 receives security information for application 120. The security information can be password information, an authentication key, or other security information. Based on the security information, the reader 102 determines a subset of available tags to associate with application 120, as illustrated at block 604. In an example, security information can be used to restrict access to payload date. As used herein, a subset of available tags can include all tags available to communicate messages to a reader device.

At block 606, the reader 102 receives security information for application 122. Based on this security information, reader 102 determines a subset of tags associated with application 122 at block 608. In an embodiment, the subset of tags associated with application 122 is different (contains different members from) the subset of tags associated with application 120. Thus, for example, application 120 can be associated with tags 110 and 111, while application 122 is associated with tags 111 and 112.

At block 610, the reader 102 is configured to report tag events to each the applications 120 and 122 based on tag messages received from different subsets of tags associated with the respective application. Thus, for example, reader 102 can report tag events to application 120 based only on tag messages received from tags 110 and 111, while the reader 102 reports tag events to application 122 based only on messages received from tags 111 and 112, and does not report tag events to application 122 based on messages received from tag 110.

The group of tags associated with a particular application can be identified in ways other than, or in combination with, security information. Thus, for example, the configuration information provided by an application can indicate tag identification information that identifies one or more tags. In another embodiment, the configuration information can identify one or more radios of the reader 102, so that the associated logical reader is configured to communicate tag events based only on tag messages received via the indicated radios.

Although particular criteria for reporting a tag event have been described individually, each logical reader or the message collector can use more than one criterion to determine whether to report a tag event. Thus, for example, a logical reader can report a tag event based on a combination of a received message's signal strength, the tag that communicated the message, the message frequency associated with the tag, or other criteria.

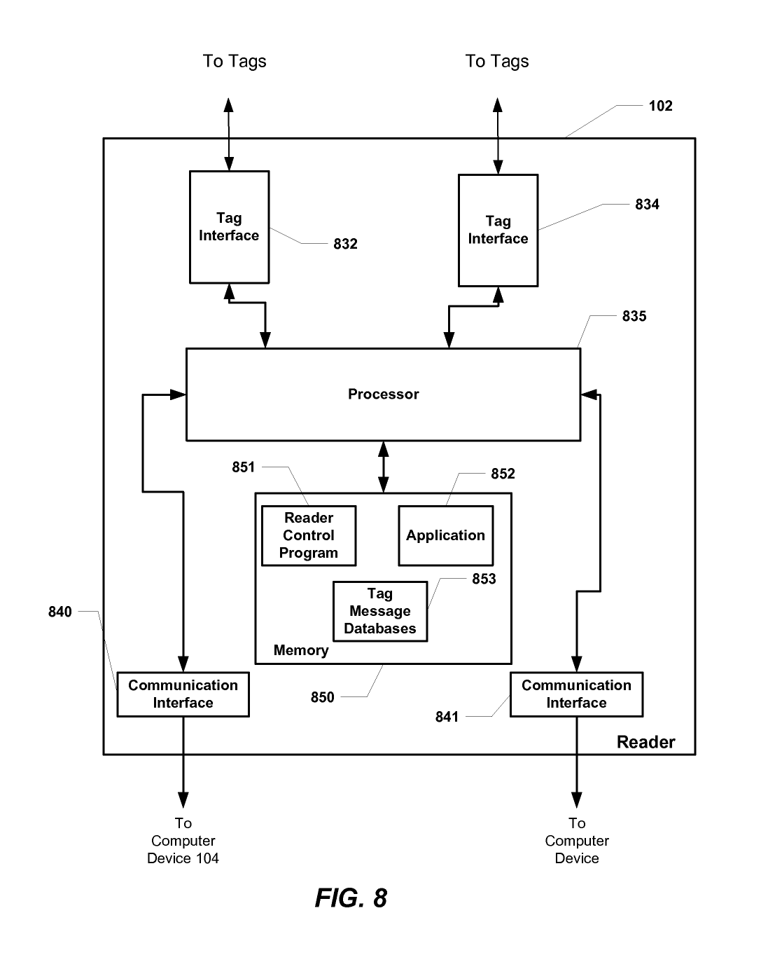

FIG. 7 illustrates a method of determining tag event configuration information for a logical reader in accordance with one embodiment of the present disclosure. At block 702, the reader 102 establishes a communication session with an application. At block 704, the reader 102 determines whether the established communication session represents a re-establishment of a previously terminated communication session. In an embodiment, each communication session is associated with an identifier that differentiates the session from other communication sessions. Upon termination of a communication session, the reader 102 can store the identifier for the terminated session, along with any other identification information that can be used to identify the session, such as the name of the application that established the session. A request for a communication session received by the reader 102 can include identification information for the session, such as the name of the application that is requesting the session. The reader 102 can compare the identification information of the request with stored identification information to determine if the request represents a re-establishment of a previous communication session. In another embodiment, the request for the communication session itself can indicate whether the request is an attempt to re-establish a previously terminated communication session.

If the reader 102 determines that the established communication session represents a re-establishment of a previously terminated session, the method flow proceeds to block 706 and the reader 102 permits access to a previously instantiated logical reader. The locally stored tag event configuration information is based on the tag event configuration information for the previously terminated communication session. Thus, the reader 102 can ensure continuity between the two communication sessions. In an embodiment, the reader 102 can also retrieve a stored database of tag messages for use by a logical reader associated with the application, the tag messages collected between established sessions.

If, at block 704, the reader 102 determines that the newly-established communication session is not a re-establishment of a previously terminated session, the method flow proceeds to block 708 and the reader 102 requests configuration information from the application that established the new session. The method flow proceeds to block 710, and the reader 102 instantiates a logical reader based on the tag event configuration information.

FIG. 8 illustrates a block diagram of the reader 102 in accordance with one embodiment of the present disclosure. As illustrated, the reader 102 includes tag interfaces 832 and 834, a processor 835, communication interfaces 840 and 841, and a memory 850. The processor 835 is connected to each of the tag interfaces 832 and 834, to the memory 850, and to each of the communication interfaces 840 and 841.

The tag interfaces 832 and 834 are interface devices each configured to receive tag messages from one or more tags (not shown). For example, the tag interfaces 832 and 834 can receive communications via radio frequency transmissions, infrared transmissions, visible light transmissions, acoustic transmissions, or any combination thereof. Accordingly, in one embodiment, each of the tag interfaces 832 and 834 is a radio device configured to receive tag messages via RF signals. In another embodiment, each of the tag interfaces 832 and 834 are devices configured to receive tag messages via infra-red (IR) signals. In still another embodiment, the tag interfaces 832 and 834 are each configured to receive tag messages via a different type of signal. For example, tag interface 832 can be a radio receiver while tag interface 834 is an IR signal receiver. Further, each of the tag interfaces 832 and 834 can be configured to communicate signals to one or more tags to communicate configuration or other information to the tags.

Each of the communication interfaces 840 and 841 are configured to provide a communications interface to one or more computer devices via one or more physical connection associated with the interface. Accordingly, each of the communications interfaces 840 and 841 can be a network interface, such as a network interface card (NIC), a USB interface, an RS-232 interface, or the like. In an embodiment, each of the communications interfaces 840 and 841 is a different kind of interface. For example, communication interface 840 can be a network interface configured to communicate with a local area network while communication interface 841 is a USB interface. Alternatively, the logical readers can communication with remote applications using the same interface or protocol.

The processor 835 is a general purpose or application-specific processor configured to execute sets of instructions in order to perform tasks associated with the instructions. Although processor 835 is illustrated as a single processor, the processor 835 can represent multiple processors, a single processor having multiple processor cores, or any combination thereof.

The memory 850 is configured to store information and retrieve stored information based on received commands. Accordingly, the memory 850 can be volatile memory, non-volatile memory, or any combination thereof. For example, memory 850 can be random access memory (RAM), read only memory (ROM), flash memory, a hard disc drive, solid state memory, or any combination thereof. The memory 850 stores programs of instructions for execution at a processor 835, including reader control program 851 and application 852. In addition, memory 850 stores tag message databases 853, which include one or more tag message databases, such as tag message databases 236 and 238 illustrated and discussed with respect to FIG. 2.

In operation, the processor 835 accesses the memory 850 to execute one or more of the stored programs. During execution of the programs, the processor 835 controls and interfaces with the tag interfaces 832 and 834 and the communication interfaces 840 and 841 to perform one or more of the methods described herein. For example, during execution of the reader control program 851, the processor 835 can perform the functions of the message collector 230, and instantiate one or more of the logical readers 235 and 237. Further, during execution of the reader control program 851, the processor 835 can concurrently execute the application 852. Application 852 is an application program similar to applications 120 and 122, and accordingly performs functions based on received tag events. Thus, during execution of the reader control program 851, the processor 835 can instantiate a logical reader to filter received tag messages and communicate tag events to the application 852 for processing. Further, the processor 835 can instantiate differently logical readers for other applications that communicate with the reader 102 via one or more of the communication interfaces 840 and 841.

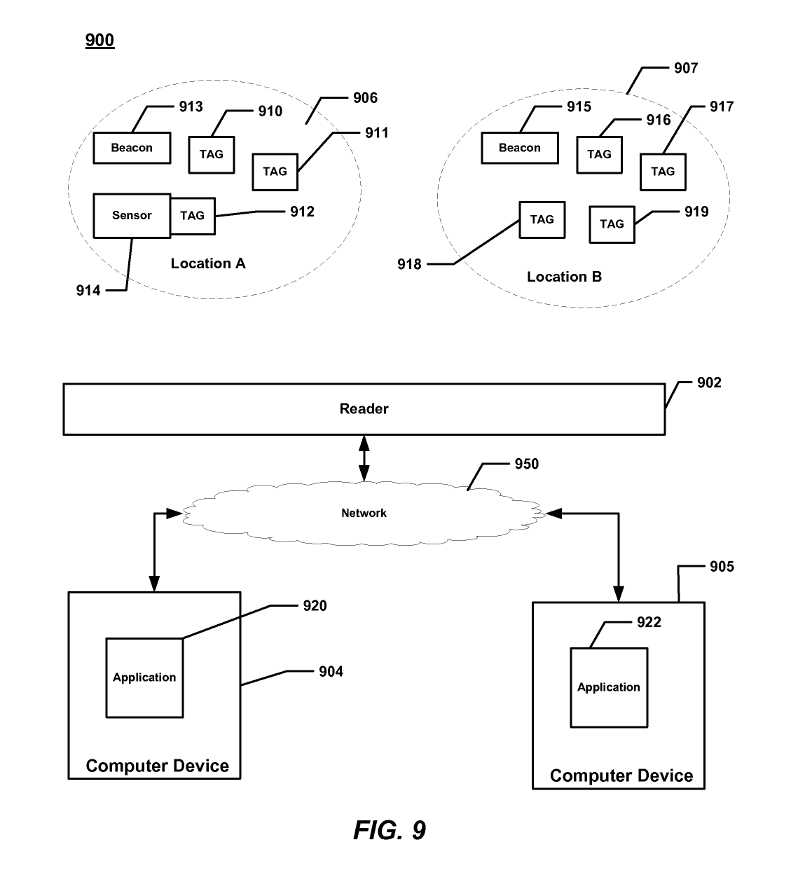

FIG. 9 illustrates a tracking system 900 in accordance with one embodiment of the present disclosure. In the illustrated embodiment, tracking system 900 includes a reader 902, computer devices 904 and 905, tags 910-912, tags 916-919, beacons 913 and 915, a sensor 914, applications 920 and 922, and a network 950. The network 950 can be a wired network, wireless network, or any combination thereof. In addition, the network 950 can be a local area network, wide area network, or any combination thereof, that is configured to provide communications between the reader 902 and one or both of computer devices 904 and 905.

In the illustrated embodiment, the tags 910-912, the beacon 913, and the sensor 914 are located at location 906 (labeled “Location A”) while tags 916-919 and beacon 915 are located at location 907 (labeled “Location B”). The locations 906 and 907 are different locations situated remotely from each other, but in sufficient proximity so that the tags of each location can communicate with the reader 902 via an RF or other signal. For example, locations 906 and 907 can be different areas of a single building, such as different offices, different portions of a warehouse, different stores in a mall, or the like. Locations 906 and 907 can also be different buildings or different rooms. In another embodiment, the locations 906 and 907 can overlap.

The beacons 913 and 915 are IR beacons each configured to periodically or continuously broadcast an IR signal. In an embodiment, locations 906 and 906 are sufficiently remote so that the tags of one location cannot detect the IR signal broadcast by a beacon at the other location. In another embodiment, the locations 906 and 907 are sufficiently close so that the tags of each location can detect the IR signal from both of the beacons 913 and 915.

The tags 910-912 and tags 916-919 are each configured to detect the IR signals broadcast by one or both of the beacons 913 and 915 and communicate tag messages based on the IR signals and other information. In an embodiment, each of the tags 910-912 and 916-919 can determine its position based on the strength of the IR signal or a location code indicated by the IR signal and report the location in each communicated tag message. Each tag message can also include other information, such as a tag identifier that uniquely identifies the tag and a group identifier that identifies a group associated with the tags. In the illustrated embodiment of FIG. 9, the tags 910-912 can be associated with one group (and one tag group identifier) while tags 916-919 are associated with another group (and a different tag group identifier). In addition, sensor 914 is an environmental sensor that provides sensed environmental information, such as temperature, pressure, humidity, radiation, the presence of liquids, or other readings, to the tag 912. Tag 912 can include the environmental information in the payload of one or more tag messages.

The reader 902 is configured to receive tag messages from each of the tags 910-912 and 916-919, filter the tag messages, and communicate tag events based on the filtered messages to each of applications 920 and 922, executing at computer devices 904 and 905 respectively. The reader 902 can customize the tag events for each application 920 and 922, so that each application receives different tag events during concurrent communication sessions.

To illustrate, in one embodiment, locations 906 and 907 can be different stores in a shopping mall, with each store owned by a different entity. The owner of the store at location 906 can execute the application 920 to track the location of assets in its store, while the owner of the store at location 907 executes the application 922 to track the location of assets at its store. The reader 902 can be configured to provide tag events based on messages received from tags at location 906 only to application 920, and provide tag events based on messages from tags at location 907 only to application 922. Thus, a common reader can be used to track the tags (and the associated assets) for stores owned by different entities, without exposing the location of the assets of one entity to the other entity.

In another example, the application 920 can be executed by the safety office of a company, while application 922 is executed by the inventory department. The sensor 914 can be a sensor that detects whether a fire is present at location 906. The reader 902 can be configured so that the information provided by the sensor results in tag events provided only to application 920, and not to application 922. Further, the reader 902 can be configured so that the location information of each of the tags 910-912 and 916-919 is provided only to application 922 and not to application 920. Thus, the information provided to different applications having different intended functions can be customized by the reader 902.

In accordance with one embodiment of the present disclosure, a reader device is disclosed that includes a first tag interface operable to receive a first set of tag messages from a first set of tags and a processor device operable to establish a first communication session with a first application and a second communication session with a second application, the first communication session concurrent with the second communication session, communicate a first set of tag events to the first application during the first communication session based on the first set of tag messages, and communicate a second set of tag events to the second application during the first communication session based on the first set of tag messages, the second set of tag events different from the first set of tag events. In one aspect the processor communicates the first set of tag events via a first event message format and communicates the second set of tag events via a second event message format, the first event message format different from the second event message format. In another aspect, the first set of tags comprises a first subset of tags and a second subset of tags different from the first subset of tags, and the first set of tag events are based on messages from the first subset of tags and the second set of tag events are based on messages from the second subset of tags.

In still another aspect, the processor is configured to determine the first set of tag events based on a comparison of a number of messages received in a period of time to a first message frequency, and determine the second set of tag events based on a comparison of the number of messages received in the period of time to a second message frequency, the second message frequency different from the first message frequency. In another aspect the processor is configured to determine a first subset of the set of tag messages based on a first signal strength, determine the first set of tag events based on the first subset of messages, determine a second subset of the set of tag messages based on a second signal strength different from the first signal strength, and determine the second set of tag events based on the second subset of messages. In yet another aspect, the processor is configured to determine, based on the plurality of tag messages, that a message has not been received from a first tag for a first duration, report to the first application that the first tag is unavailable based on the first duration, and communicate the second set of tag events without reporting the first tag is unavailable.

In another, the processor is configured to determine the first set of tag events based on first security information received from the first application, and determine the second set of tag events based on second security information received from the second application. In another aspect the set of tags includes a first subset of tags and a second subset of tags different from the first subset of tags, and the processor is configured to determine the first subset of tags based on the first security information, determine the second subset of tags based on the second security information, determine the first set of tag events based only on messages from the first subset of tags, and determine the second set of tag events based only on messages from the second subset of tags.

In another aspect, the processor is configured to determine the first set of tag events based on first configuration information received from the first application; and determine the second set of tag events based on second configuration information received from the second application.

In another aspect, the reader device includes a second tag interface operable to receive a second set of tag messages from a second set of tags, and the processor is configured to determine the first set of tag events based only on the first set of tag messages and determine the second set of tag events based only on the second set of tag messages.

In another aspect, the reader device includes a first communication interface configured to communicate with a first computer device remote from the reader device and a second communication interface configured to communicate with a second computer device remote from the reader device, and the processor is configured to communicate the first set of tag messages via the first communication interface and communicate the second set of tag messages via the second communication interface.

In another aspect, the reader device includes a communication interface configured to communicate with a first computer device remote from the reader device, and the processor is configured to communicate the first set of tag messages via the first communication interface and communicate the second set of tag messages to the second application executing at the processor.

In accordance with another embodiment of the present disclosure, a tag reader system includes a set of tags operable to communicate a set of tag messages and a reader device that includes a first tag interface operable to receive the set of tag messages and a processor device operable to establish a first communication session with a first application and a second communication session with a second application, the first communication session concurrent with the second communication session, communicate a first set of tag events to the first application during the first communication session based on the first set of tag messages, and communicate a second set of tag events to the second application during the first communication session based on the first set of tag messages, the second set of tag events different from the first set of tag events.

In one aspect the processor of the reader system communicates the first set of tag events via a first event message format and communicates the second set of tag events via a second event message format, the first event message format different from the second event message format.

In another aspect the set of tags includes a first subset of tags and a second subset of tags different from the first subset of tags, and the first set of tag events are based on messages from the first subset of tags and the second set of tag events are based on messages from the second subset of tags.

In accordance with another embodiment of the present disclosure, a method, includes establishing a first communication session between a reader device and a first application for a first period, establishing a second communication session between a reader device and a second application for a second period, the second period overlapping the first period, receiving at the reader device a plurality of tag messages from a plurality of tags during the first communication session, communicating, during the first communication session, a first set of tag events to the first application based on the plurality of tag messages, and communicating, during the second communication session, a second set of tag events to the second application based on the plurality of tag messages, the second set of tag events different from the first set of tag events.

In one aspect, the first set of tag events is communicated via a first event message format and the second set of tag events is communicated via a second event message format.

In another aspect, the plurality of tags includes a first subset of tags and a second subset of tags different from the first subset of tags, and the first set of tag events are based on messages from the first subset of tags and the second set of tag events are based on messages from the second subset of tags.

In another aspect, the method includes determining the first set of tag events based on a comparison of a number of messages received in a third period of time to a first message frequency and determining the second set of tag events based on a comparison of the number of messages received in the third period of time to a second message frequency, the second message frequency different from the first.

In still another aspect, the method includes determining a first subset of the plurality of tag messages based on a first signal strength, determining the first set of tag events based on the first subset of messages, determining a second subset of the plurality of tag messages based on a second signal strength different from the first signal strength, and determining the second set of tag events based on the second subset of messages.

In yet another aspect, the method includes determining, based on the plurality of tag messages, that a message has not been received from a first tag for a first duration, communicating the first set of tag events including reporting to the first application that the first tag is unavailable based on the first duration, and communicating the second set of tag events, which comprises communicating the second set of tag events without reporting the first tag is unavailable.

In another aspect, the method includes determining the first set of tag events based on first security information received from the first application, and determining the second set of tag events based on second security information received from the second application.

In still another aspect, the plurality of tags comprises a first subset of tags and a second subset of tags different from the first subset of tags, and the method further includes determining the first subset of tags based on the first security information, determining the second subset of tags based on the second security information, and the first set of tag events are based only on messages from the first subset of tags and the second set of tag events are based only on messages from the second subset of tags.

In yet another aspect, the method includes determining the first set of tag events based on first configuration information received from the first application and determining the second set of tag events based on second configuration information received from the second application.

In another aspect, the method includes storing the first configuration information at the reader device and in response to establishing a third communication session between the reader device and the first application for a third period, retrieving the first configuration information at the reader device.

In accordance with another embodiment of the present disclosure, a system includes a plurality of tags and a reader device including a receiver device to receive a plurality of tag messages from the plurality of tags, a message collector to collect the plurality of tag messages, a first logical reader to determine a first set of tag events based on the plurality of tag messages, a second logical reader to determine a second set of tag events based on the plurality of tag messages, the second set of tag events different from the first set of tag events, and a communication interface to communicate the first set of tag events to a first application and the second set of tag events to a second application.

In one aspect, the system includes a first computer device to execute the first application. In another aspect, the system includes a second computer device to execute the second application.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A reader device comprising:
a receiver device to receive a plurality of tag messages from a plurality of tags;
a message collector to collect first and second sets of the plurality of tag messages based on a union of a first criteria associated with a first remote application and a second criteria associated with a second remote application;
a first logical reader to determine a first set of tag events based on the first set of the plurality of tag messages and to provide the first set of tag events to the first remote application; and
a second logical reader to determine a second set of tag events based on the second set of the plurality of tag messages and to provide the second set of tag events to the second remote application.

2. The reader device of claim 1, wherein the first criteria is associated with a tag identifier, a group identifier, a location code, a status with regard to movement, a signal strength associated with a IR beacon, a signal strength associated with the RF message, an existence or type of payload data, another status parameters within the tag message, or any combination thereof.

3. The reader device of claim 2, wherein the first criteria includes collecting tag messages including a designated group identified.

4. The reader device of claim 2, wherein the first criteria include collecting tag messages including a location code.

5. The reader device of claim 1, wherein determining the first set of tag events includes comparing a value of an element within a tag message to a previously determined value.

6. The reader device of claim 1, wherein determining the first set of tag events includes selecting a tag message based on timing.

7. The reader device of claim 1, further comprising a communication interface, the first logical reader to provide the first set of tag events to the first remote application via the communication interface.

8. A tag reader system comprising:
a set of tags operable to communicate a set of tag messages;
a reader device comprising:
a receiver device to receive a plurality of tag messages from a plurality of tags;
a message collector to collect first and second sets of the plurality of tag messages based on a union of a first criteria associated with a first remote application and a second criteria associated with a second remote application;
a first logical reader to determine a first set of tag events based on the first set of the plurality of tag messages and to provide the first set of tag events to the first remote application; and
a second logical reader to determine a second set of tag events based on the second set of the plurality of tag messages and to provide the second set of tag events to the second remote application.

9. A reader device, comprising:
a first tag interface operable to receive a first set of tag messages from a first set of tags;
a processor device operable to:
establish a first communication session with a first application and a second communication session with a second application, the first communication session concurrent with the second communication session;
communicate a first set of tag events to the first application during the first communication session based on the first set of tag messages; and
communicate a second set of tag events to the second application during the first communication session based on the first set of tag messages, the second set of tag events different from the first set of tag events.

10. The reader device of claim 9, wherein establishing the first communication session includes instantiating a first logical reader, the processor device operable to establish a message collector to collect tag messages based on a union of criteria associated with logical readers including the first logical reader.

11. The reader device of claim 9, wherein the processor communicates the first set of tag events via a first event message format and communicates the second set of tag events via a second event message format, the first event message format different from the second event message format.

12. The reader device of claim 9, wherein the first set of tags comprises a first subset of tags and a second subset of tags different from the first subset of tags, and wherein the first set of tag events are based on tag messages from the first subset of tags and the second set of tag events are based on tag messages from the second subset of tags.

13. The reader device of claim 9, wherein the processor is configured to:
determine the first set of tag events based on a comparison of a number of messages received in a period of time to a first message frequency; and
determine the second set of tag events based on a comparison of the number of messages received in the period of time to a second message frequency, the second message frequency different from the first message frequency.

14. The reader device of claim 9, wherein the processor is configured to:
determine a first subset of the set of tag messages based on a first signal strength;
determine the first set of tag events based on the first subset of messages;
determine a second subset of the set of tag messages based on a second signal strength different from the first signal strength; and
determine the second set of tag events based on the second subset of messages.

15. The reader device of claim 9, wherein the processor is configured to:
determine, based on the plurality of tag messages, that a message has not been received from a first tag for a first duration; and
report to the first application that the first tag is unavailable based on the first duration; and
communicate the second set of tag events without reporting the first tag is unavailable.

16. The reader device of claim 9, wherein the processor is configured to:
determine the first set of tag events based on first security information received from the first application; and
determine the second set of tag events based on second security information received from the second application.

17. The reader device of claim 16, wherein the set of tags comprises a first subset of tags and a second subset of tags different from the first subset of tags, and wherein the processor is configured to:
determine the first subset of tags based on the first security information;
determine the second subset of tags based on the second security information; and
determine the first set of tag events based only on messages from the first subset of tags; and
determine the second set of tag events based only on messages from the second subset of tags.

18. The reader device of claim 9, wherein the processor is configured to:
determine the first set of tag events based on first configuration information received from the first application; and
determine the second set of tag events based on second configuration information received from the second application.

19. The reader device of claim 9, further comprising:
a second tag interface operable to receive a second set of tag messages from a second set of tags; and
wherein the processor is configured to determine the first set of tag events based only on the first set of tag messages and determine the second set of tag events based only on the second set of tag messages.

20. The reader device of claim 9, further comprising:
a first communication interface configured to communicate with a first computer device remote from the reader device;
a second communication interface configured to communicate with a second computer device remote from the reader device; and
wherein the processor is configured to communicate the first set of tag messages via the first communication interface and communicate the second set of tag messages via the second communication interface.

21. The reader device of claim 9, further comprising:
a communication interface configured to communicate with a first computer device remote from the reader device; and
wherein the processor is configured to communicate the first set of tag messages via the first communication interface and communicate the second set of tag messages to the second application executing at the processor.

22.-37. (canceled)
